(19) United States
(12) Patent Application Publication
(10) Pub. No.: US 2021/0174341 A1
(43) Pub. Date: Jun. 10, 2021

(54) SMART GIFT SYSTEMS AND METHODS

(71) Applicant: Fingo Inc., San Francisco, CA (US)

(72) Inventors: Robson Araujo, Mountain View, CA (US); Ranveer Kunal, San Francisco, CA (US); Andre Madeira, Saratoga, CA (US); Wisam Dakka, San Francisco, CA (US)

(21) Appl. No.: 17/117,026

(22) Filed: Dec. 9, 2020

Related U.S. Application Data
(60) Provisional application No. 62/946,228, filed on Dec. 10, 2019.

(51) Int. Cl. G06Q 20/34; G06Q 20/32; G06Q 20/38

(52) U.S. Cl. CPC G06Q 20/351; G06Q 20/387; G06Q 20/3223

(57) ABSTRACT

Methods and systems for delivering and distributing smart (customizable) gifts. One of the methods includes receiving a request from a gift sender for a smart gift, the smart gift including at least one user customizable constraint and a specified value; creating the smart gift; receiving a claim to the smart gift from a potential gift recipient; receiving authorization for access to at least one account of the potential gift recipient; matching a transaction reflected in the at least one account of the potential gift recipient to the at least one customizable and programmable constraint; and transferring at least a portion of the specified value to an account of the potential gift recipient in response to the matching.

### CROSS-REFERENCE TO RELATED APPLICATION

This application claims priority to U.S. Provisional Application No. 62/946,228, entitled “Smart Gift Systems and Methods,” filed Dec. 10, 2019, the entire contents of which are incorporated herein by reference in its entirety.

### BACKGROUND

### Technical Field

This specification relates to exchanging gifts or rewards without the drawbacks of traditional physical or electronic gift cards.

### Background

A gift card is a prepaid stored-value money card, usually issued by a retailer or bank, to be used as an alternative to cash for purchases within a particular store or related business. Gift cards are also given out by employers or organizations as rewards or gifts. Similarly, Peer-to-peer (P2P) transactions are electronic money transfers made from one person to another through an intermediary, typically referred to as a P2P payment application. P2P payments can be sent and received via mobile device or any home computer with access to the Internet, offering a convenient alternative to traditional payment methods. Neither gift cards or P2P transactions fully satisfy consumer demand for transferring value.

### SUMMARY

This specification describes technologies for delivering and distributing smart, digital, and programmable gifts, e.g., smart gifts that have customizable constraints. Gifts can combine a) value, e.g., value in a currency such as cash or bitcoin, and b) at least one constraint. In certain implementations:
1. There is no physical or electronic gift card;
2. A gift receiver can activate a smart gift by linking their credit card or other account to a smart gift system account;
3. Funds are distributed to a gift receiver as they use their credit card or other account on a relevant transaction;
4. A smart gift sender can program the smart gift and decide the nature of where the value is spent (for example, a smart gift sender can send a gift for any coffee purchase in San Francisco);
5. Smart gift senders can send a smart gift to a receiver entirely over social networks or other platforms digitally, but they can equally print a QR code of the gift on a holiday card and exchange it physically.

In general, one innovative aspect of the subject matter described in this specification can be embodied in methods that include the actions of: receiving a request from a gift sender for a smart gift, the smart gift including at least one user customizable constraint and a specified value; creating the smart gift; receiving a claim to the smart gift from a potential gift recipient; receiving authorization for access to at least one account of the potential gift recipient; matching a transaction reflected in the at least one account of the potential gift recipient to the at least one customizable and programmable constraint; and transferring at least a portion of the specified value to an account of the potential gift recipient in response to the matching. These methods can be applied to a plurality of requests for smart gifts and to the matching of a plurality of transactions. The plurality of requests and transactions can occur simultaneously or nearly simultaneously, e.g., with a minute.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. Creating a smart gift can include creating a smart gift shareable link and providing the smart gift shareable link to the gift sender, the smart gift shareable link configured to be forwarded by the gift sender to potential gift recipient(s). The gift sender/creator can provide user instructions/selections for constraints from the user interface elements shown, e.g., in FIG. 7A and the system converts the constraints into instructions using a suitable language, e.g., the Go programming language. The shareable link can specify from whom (e.g., the sender) to whom (e.g., a specified person or a group of people such as the first 10 to claim the gift) and the link can contains a reference to machine generated code/instructions that manifest the constraints to follow. The instructions reference can include parameters.

The method can further includes receiving from the gift sender an indication of a recipient and forwarding the recipient a notification of the smart gift. The request can further include a personal text message and artwork from the gift sender. Receiving authorization for access to at least one account of the potential gift recipient includes receiving authorization to match a received smart gift to an activity at the at least one account. The method can further include segregating the specified value into a holding account. The customizable and programmable constraint can be provided by the user.

The customizable and programmable constraint can be an option the gift sender selects from a set of options presented to the gift sender. The matching step can include receiving transaction data from the at least one online account. The at least one customizable constraint can include at least one geolocation constraint, at least one time constraint, or a combination of the at least one geolocation constraint and the at least one time constraint. The at least one customizable constraint can be specified by the sender. In certain implementations, the at least one customizable constraint does not specify a value of the smart gift, a recipient of the smart gift, or a sole merchant at which the smart gift can be redeemed. Receiving a request from a gift sender for a smart gift can include a specified value for the smart gift and an account from which the gift sender wants to withdraw the specified value to fund the smart gift. Creating the smart gift can include creating a shareable link that can access smart gift functionality and enticing sharing of the smart gift using the shareable link.

Another innovative aspect of the subject matter described in this specification can be embodied in methods that include the actions of: receiving a request from a reward sender for a smart reward, the request including at least one customizable constraint and a specified value parameter; segregating the specified value into a holding account; creating the smart reward; receiving a claim to the smart reward from a potential reward recipient; receiving authorization for access to at least one online account of the potential reward recipient; matching a transaction in the at least one online account of the potential reward recipient to the at least one customizable constraint; and transferring at least a portion of the specified value to an account of the potential reward recipient in response to the matching.

The subject matter described in this specification can be implemented in particular embodiments so as to realize one or more of the following advantages. The smart gift system allows a smart gift sender to support the sender's and/or the recipient's goals better by allowing the sender to provide customized constraints that match those goals. The system helps a user to keep track of their gifts and not lose them. The system allows a user to send gifts for merchants that do not have gift card options and to send smart gifts that cover arbitrary groups of merchants. The system allows a user to use gifts with minimal effort and without slowing down a purchasing process. In the smart gift system described in this specification, a user does not have to worry about forgetting to apply a smart gift as the smart gift can be redeemed automatically and/or the user can be notified when a smart gift applies to a user's transaction. Certain implementations allow for cash redemption of leftover amounts. In certain implementations smart gifts never expire. In addition, a receiver of a smart gift can still earn miles on their credit card while at the same time redeeming an applicable smart gift. The computer-implemented smart gift systems and methods described in this invention can process more than a hundred, more than a thousand, more than ten thousand, more than a hundred thousand or even more than a million smart gift transactions per minute and such automated systems and methods can utilize server farms and server balancing techniques to avoid downtime and latency, so as to be able to provide service 24 hours a day, seven days a week, 365 days a year, if desired. Furthermore, the automated constraint matching engine and the shareable link described in this specification result in less need for customer interactions with the system, reducing bandwidth and processor consumption.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of one example of a smart gift system and actors that interact with the system.

FIG. 2 is a diagram showing example inputs to an exemplary ingestion engine used in the redeeming process.

FIG. 3 is a diagram showing an example of an entry processor for use with an ingestion engine.

FIG. 4 is a diagram showing an example of a gift matching engine.

FIG. 5 is a diagram showing an example of a payment process.

FIG. 6 is a flow chart of a smart gift process.

FIGS. 7A to 7F show an example of a gift sending process.

FIGS. 8A to 8H show an example of a new user sign-up process.

FIGS. 9A to 9G show an example of a gift receiving process.

FIGS. 10A to 10C show an example of applying a gift to detected transactions.

FIGS. 11A and 11B show an example of sent and received smart gifts.

Like reference numbers and designations in the various drawings indicate like elements.

### DETAILED DESCRIPTION

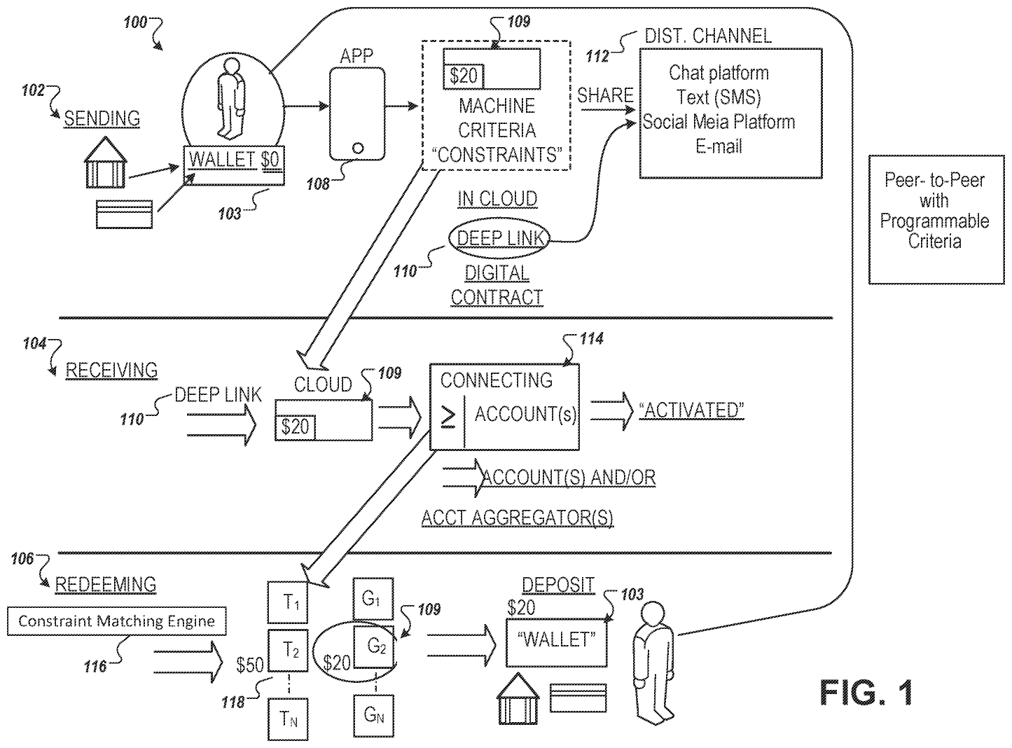

This specification describes technologies for delivering and distributing smart, digital, and programmable gifts, e.g., smart gifts that have customizable constraints. FIG. 1 is a diagram of one example of a smart gift system 100 and actors that interact with the system. FIG. 1 illustrates a sending workflow 102, a receiving workflow 104, and a redeeming workflow 106. In the sending workflow 102, a user interacts with an application 108, e.g., a mobile phone application, or a website to create a smart gift 109 that has a value, e.g., $20 for tea. As part of the funding of the smart gift by the sender, the sender can authorize a transfer to the smart gift system. For example, the gift sender can transfer funds from the sender's bank or debit card to a wallet 103 (e.g., a white-labelled bank account) to which the smart gift system can obtain authorized access. The smart gift 109 does not necessarily have a recipient at this point, but it has matching criteria, i.e., some logic or programmable criteria. A smart gift can be a set of instructions stored using cloud computing (e.g., on-demand computer system resources, especially data storage and computing power, without direct active management by the user).

The instructions can include instructions that the recipient of the smart gift is entitled to a specified amount under specified constraints. At a particular point in the workflow, the system can require that the card can only be redeemable by one specified person or by a specified set of people. The smart gift 109 can be represented/accessed via a deep link 110 that can be given to anyone. The information governing the smart gift can be stored in cloud computing resources. Alternatively, the smart gift information can be stored on other resources, e.g., dedicated smart gift system servers. A user can share the deep link 110 for the smart gift 109 using any of a variety of distribution channels 112 such as a social media platform, a chat platform or an email platform.

In the receiving workflow 104 once a receiver receives the deep link, a receiver can activate the receiving workflow by clicking on the deep link. As noted above, in certain implementations a user does not need to assign a recipient. In other implementations, a user can be required to assign a. specific recipient to ensure only the recipient is verified and allowed to redeem the smart gift. In certain implementations, the smart gift system can attach an expiration date to the deep link to help avoid unauthorized uses.

In the implementation illustrated in FIG. 1, the deep link is a plain vanilla link such that whoever activates the link first is the one who can activate it. In certain implementations, one gift card can be usable multiple times. For example a user can create a $1000 smart gift that is useable in $2.0 increments so the first 50 clicks/activations of the smart gift deep link 110 that come from receivers are authorized by the smart gift system.

Once the receiver activates (e.g., clicks on) the deep link for the smart gift, the smart gift system retrieves the smart gift information identified by the deep link (e.g., retrieves the smart gift information from cloud computing resources). In the illustrated example, the smart gift is for $20. Once the receiver clicks on the deep link to activate the smart gift, if the receiver is a first time receiver, the smart gift system prompts the user to connect 114 at least one account to the smart gift system. The at least one account can be: an account aggregator; one or more financial accounts (such as a bank account or credit card account); one or more other types of accounts (such as an online retailer account); or a combination of the above. Once the receiver connects at least one third party account to the receiver's smart gift system wallet/account, the smart gift can be activated. In certain implementations, if the receiver has already connected at least one account the receiver can simply activate the smart gift by clicking on the deep link 110.

In the redeeming workflow 106, after the receiver claims the smart gift, the smart gift system attempts to match 116 transactions 118 in the at least one receiver account against the smart gift 109, the at least one account being connected to the smart gift system. Indeed, if the receiver has claimed multiple smart gifts, the system can attempt to match transactions against all the smart gifts. The smart gift system can use one of a variety of processes for determining which smart gift to use when more than one smart gift applies: first in time, amount of money on card (least or most), breadth of card category (least broad or most broad), past user purchasing behavior (e.g., select the card that applies the least to the receiver's purchasing habits), and/or, allow the receiver to select which of the applicable cards to use.

The system attempts to match 116 transactions to smart gifts as the transaction data (e.g., data for transactions T₁, T₂ . . . T_{N}) arrives over time in the smart gift system. The process can perform a reverse matching on transactions. When there is a match between a transaction (e.g., a $50 transaction for a number of tea drinks matches with the $20 smart gift for tea), qualifying funds, e.g. the $20, is deposited in the smart gift receiver's smart gift system wallet. The smart gift system wallet can be a white-labelled bank account. The account for the smart gift system wallet can be created at the moment that the system is prepared to transfer the funds to the wallet or the receiver can create the account prior to the funds transfer. In certain implementations, the smart gift system can allow a receiver to transfer qualifying funds to a receiver's debit card.

Smart gift constraints can take a variety of forms. For example, a child's grandparents can fund a $200 smart gift for the child that is constrained to go to a savings account for the child. Even if the child has no savings account, the grandparents can just give the smart gift with the constraint that the money should go to a savings account. Thus, implementations of the smart gift system can address not just merchant-based smart gifts. The constraints can be time-based and/or location based. For example, one can specify that the recipient can use the smart gift only for Thanksgiving and/or only for a physical area (e.g., using one or more geo-filters). By allowing flexibility on the constraints a gift sender can select, smart gifts allow a sender to support the sender and/or the receiver's goals better relative to existing gifting systems.

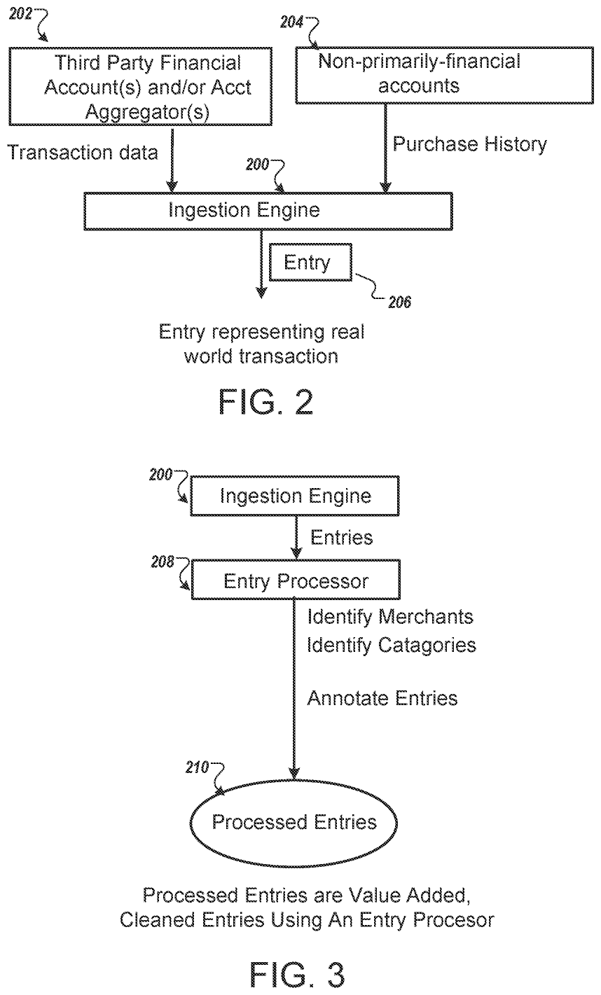

Having described workflows for certain implementations of a smart gift system, this specification now turns to describing the constraint matching engine 116 shown in FIG. 1. FIG. 2 is a diagram showing example inputs to an exemplary ingestion engine 200 that is part of the constraint matching engine 116. The ingestion engine 200 receives transaction data from 3rd party financial account(s) and/or account aggregator(s) 202 (such as banks, credit card companies and/or financial account aggregators) and receives purchase history data from accounts (such as online retailer accounts) that are not primarily financial accounts. The ingestion engine then processes the transaction and purchase data to produce entries that represent transactions. The smart gift system does not aggregate the raw data it receives from third parties and assumes that each entry provided is an entry in the smart gift system. The smart gift system proceeds as follows. For traditional financial institutions where the transaction descriptions involve a merchant and an amount, each financial transaction is an entry in the smart gift system. For non-financial institutions or non-traditional financial institutions (e.g., ecommerce, ride sharing or P2P funds transfer), there can be additional processing. For an ecommerce site an order that has multiple items and can be processed to produce multiple entries. For a ride-sharing platform, the data can be broken down into individual ride entries. For P2P payments, an entry can represent a single funds transfer.

FIG. 3 is a diagram showing an example of an entry processor 208 for use with an ingestion engine, such as the ingestion engine 200 of FIG. 2. The ingestion engine 200 provides the entries it produces to the entry processor 208. The entry processor 208 identifies merchants and categories for the entry to produce processed entries 210. The entry processor also annotates entries, e.g., by flagging from which account an entry came.

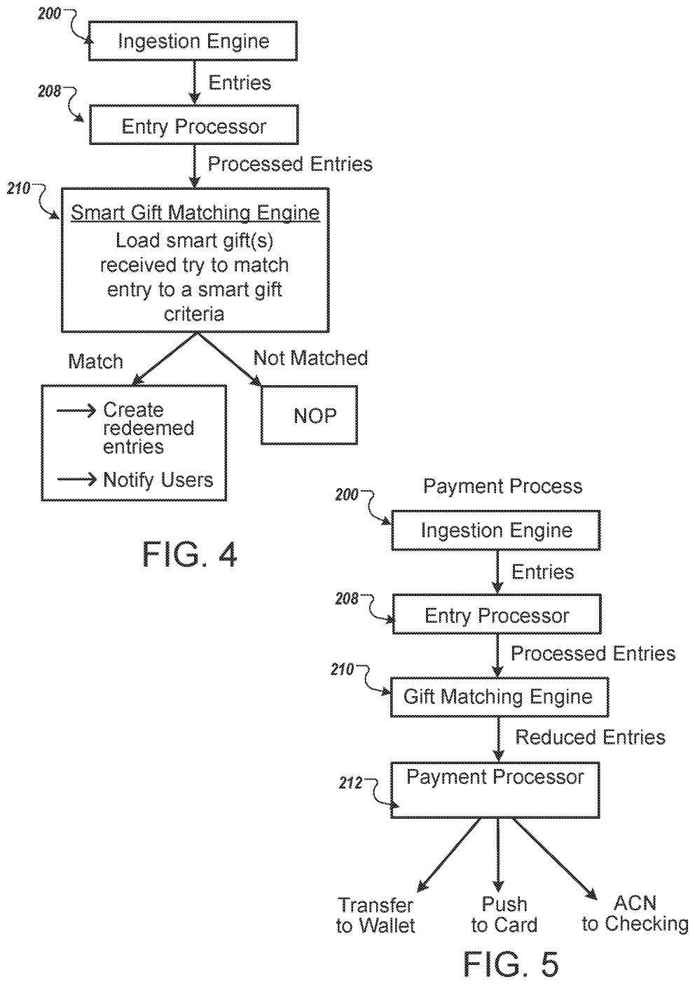

FIG. 4 is a diagram showing an example of a smart gift constraint-to-transaction matching engine 210. An entry processor. such as the entry processor 208 shown in FIG. 3, can provide processed entries to a smart gift matching engine 210 which loads smart gifts received by a receiver and attempts to match processed entries to smart gift criteria. If there is a match the system creates redeemed entries and notifies the receiver/user. If there are no matches, no operation is necessary. The smart gift constraint-to-transaction matching enginge 210 can use a variety of criteria to match a constraint for a smart gift to a transaction by a recipient. For example, store name keywords in the transaction can be matched to store names keywords in the transaction and this signal can be combined with geolocation data. Similary, pricing constraints from the smart gift can be applied to the price of the transaction perhaps resulting in an offset as opposed to providing credit for the full amount of the transaction in question.

FIG. 5 is a diagram showing an example of a payment process for implementations of a smart gift system. Once the smart gift constraint-matching engine 210 produces reduced redeemed entries that represent matched smart gifts, the smart gift matching engine 210 provides those reduced entries to a payment processor 212. In certain implementations, the payment processor then can transfer the qualifying funds to: the relevant user's smart gift system wallet, the relevant user's debit card, or the relevant user's checking account.

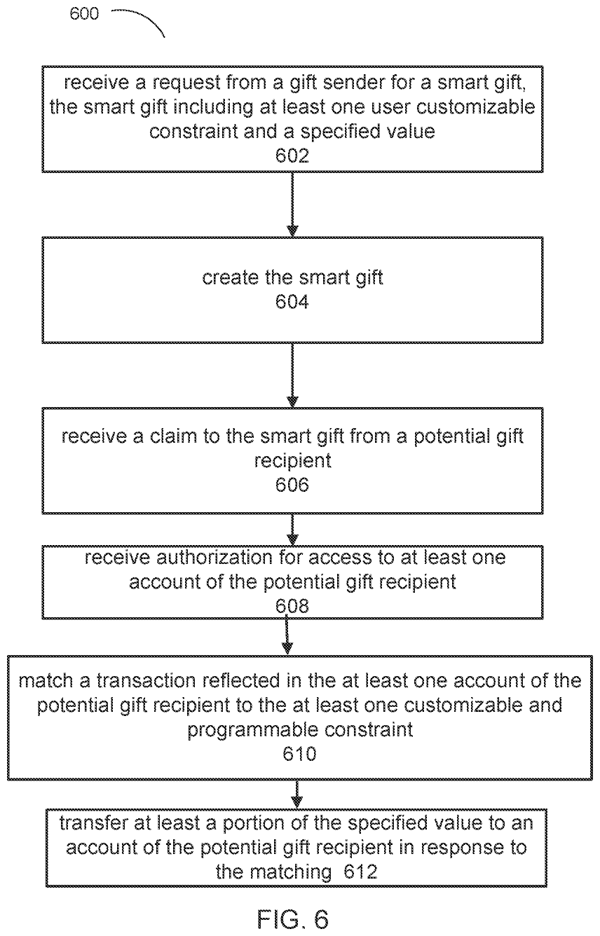

FIG. 6 is a flowchart of an example process 600 for sending, receiving and redeeming a smart gift. For convenience, the process 600 will be described as being performed by a system of one or more computers, located in one or more locations, and programmed appropriately in accordance with this specification. For example, a smart gift system, e.g., the smart gift system 100 of FIG. 1, appropriately programmed, can perform the process 600. The illustrated process including receiving 602 a request from a gift sender for a smart gift, the smart gift including at least one user customizable constraint and a specified value; creating 604 the smart gift; receiving 606 a claim to the smart gift from a potential gift recipient; receiving 608 authorization for access to at least one account of the potential gift recipient; matching 610 a transaction reflected in the at least one account of the potential gift recipient to the at least one customizable and programmable constraint; and transferring 612 at least a portion of the specified value to an account of the potential gift recipient in response to the matching.

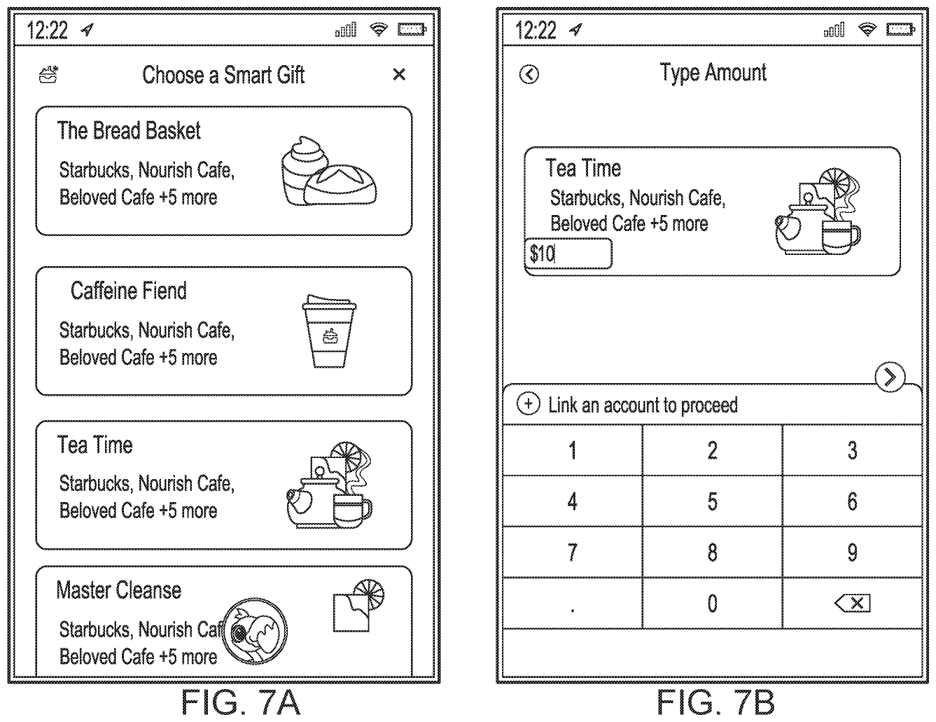

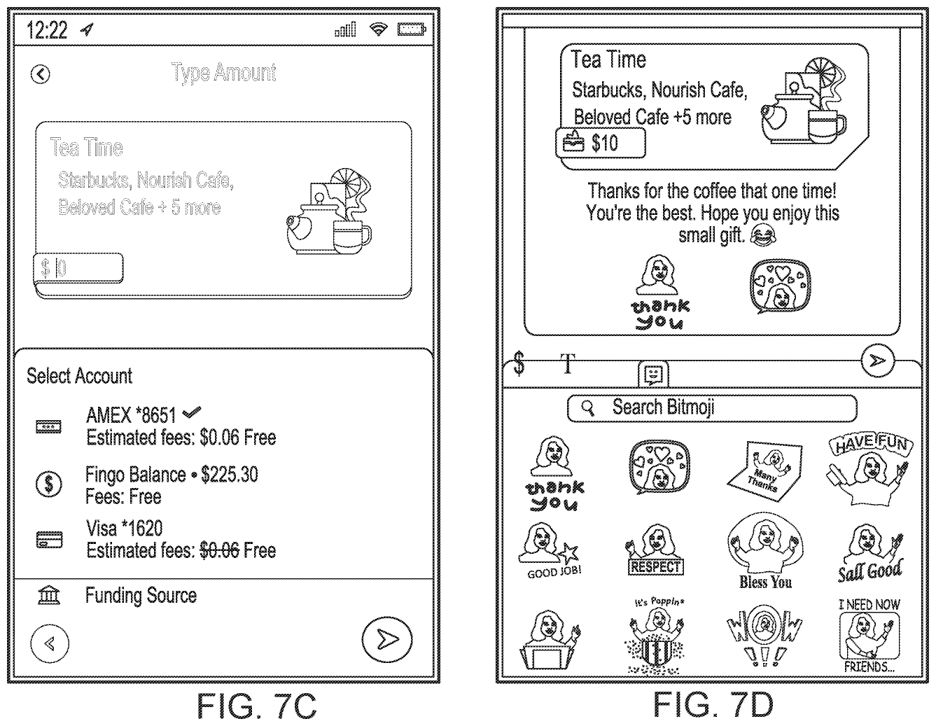

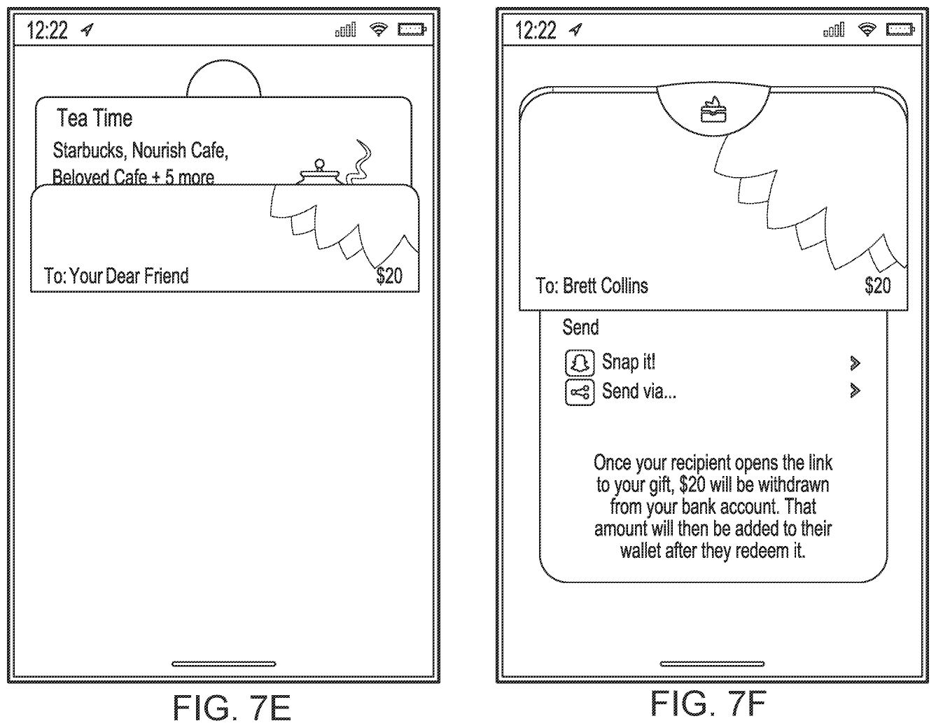

FIGS. 7A to 7F show exemplary user interface screen shots that are part of an example of a gift sending process. FIG. 7A shows a selection of pre-constructed smart gifts. A smart gift sender can also create their own customized smart gift. FIG. 7B shows a sender specifying the value of a selected smart gift. FIG. 7C shows a user interface that allows a sender to select one of the sender's accounts to use in providing the specified value for the smart gift. FIG. 7D shows a user interface to allow the sender to personalize the smart gift, e.g., with text and artwork. FIG. 7E shows completion of the smart gift. FIG. 7F shows a user interface that allows the sender to share the smart gift with one or more recipients. As noted above, at a particular point in the sending workflow, the system can require that the card can only be redeemable by one specified person or by a specified set of people. This requirement can come at a variety of times, e.g., before the user arrives at the display shown in FIG. 7A or alternatively at the step where a sender selects a recipient of the smart gift, e.g., at FIG. 7F.

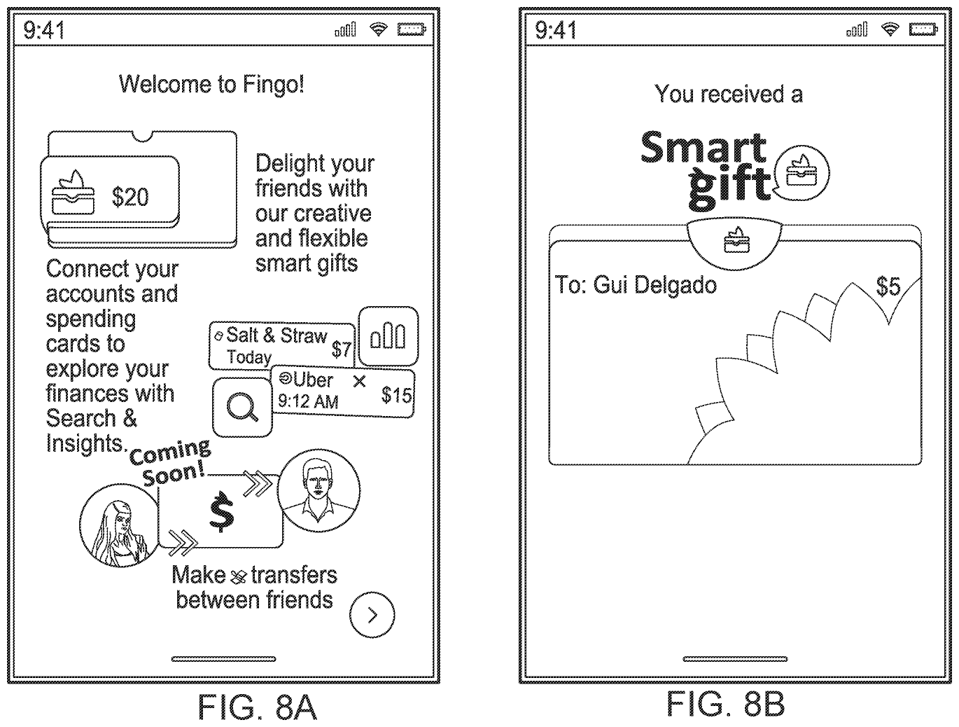

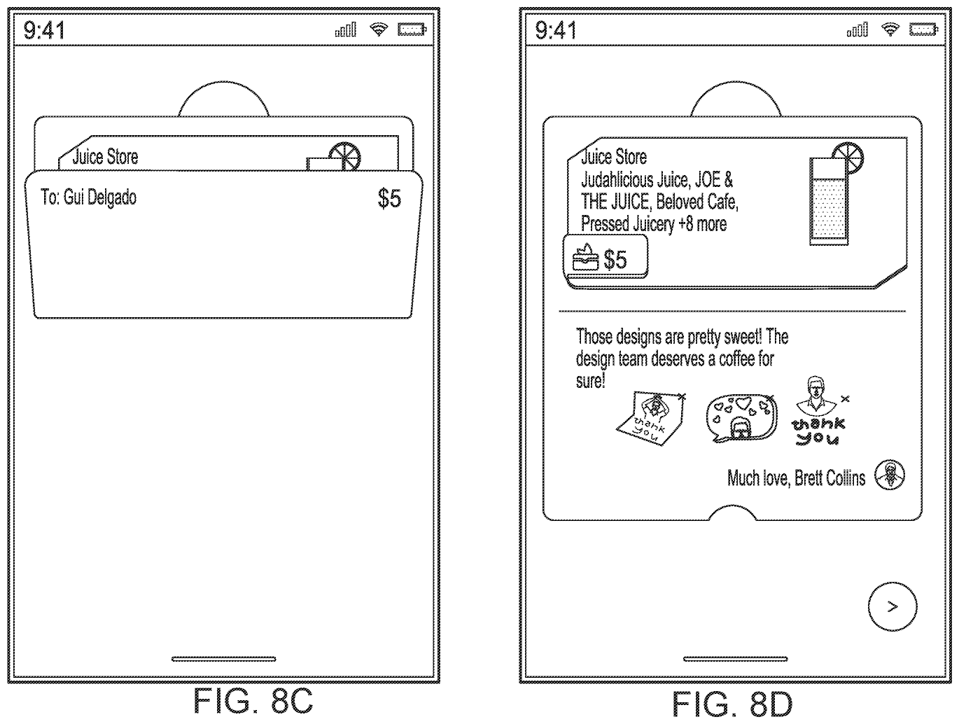

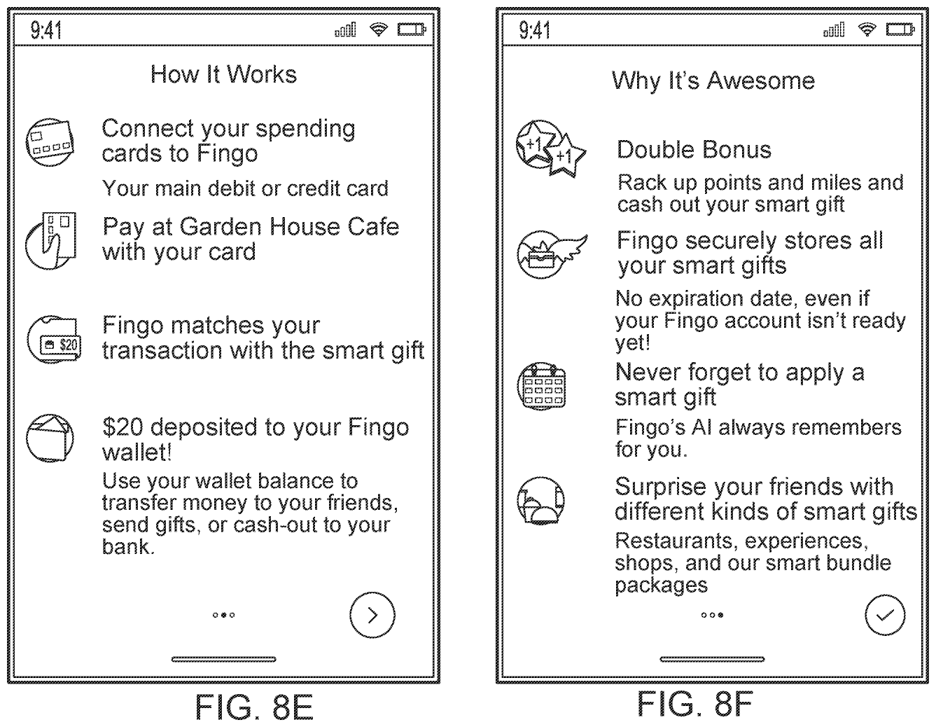

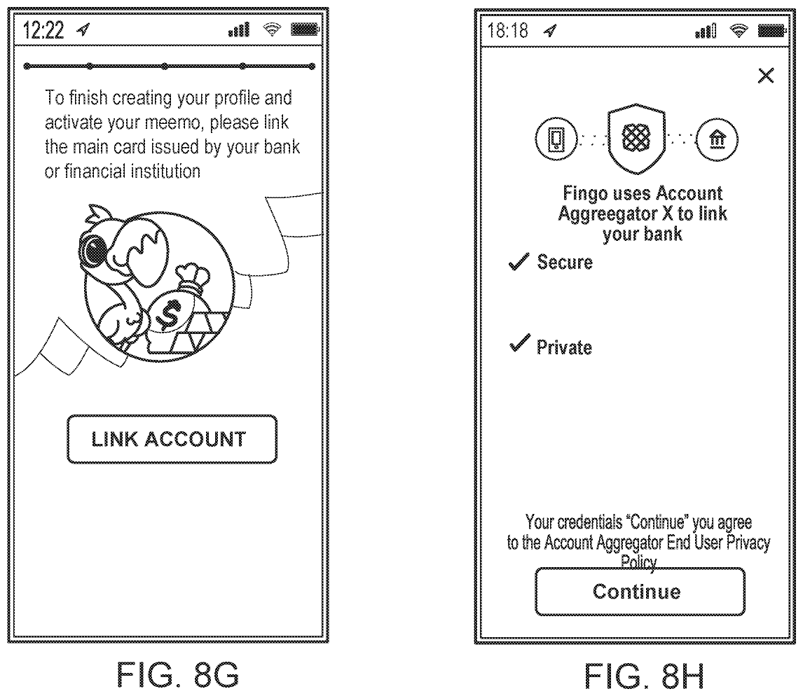

FIGS. 8A to 8H show an example of a new user sign-up process. FIG. 8A shows a display that welcomes a user to the smart gift ecosystem. FIG. 8B is a user interface notifying a user that they have received a smart gift. FIG. 8C shows the receiver activating the smart gift, e.g. by clicking on a graphical display of the smart gift. FIG. 8D shows information associated with the smart gift including value, information about constraints associated with the smart gift and potentially some personalized treatment, e.g., personalized message and/or artwork. FIG. 8E shows a display that informs a user about aspects of how the smart gift system works. FIG. 8F is a display noting advantages of an implementation of a smart gift system. FIG. 8G is a display providing an ability of a smart gift receiver to link an account, e.g., a bank account or an account aggregator account such as Plaid to the smart gift system. FIG. 8H is a display providing further information about linking an account aggregator to the smart gift system.

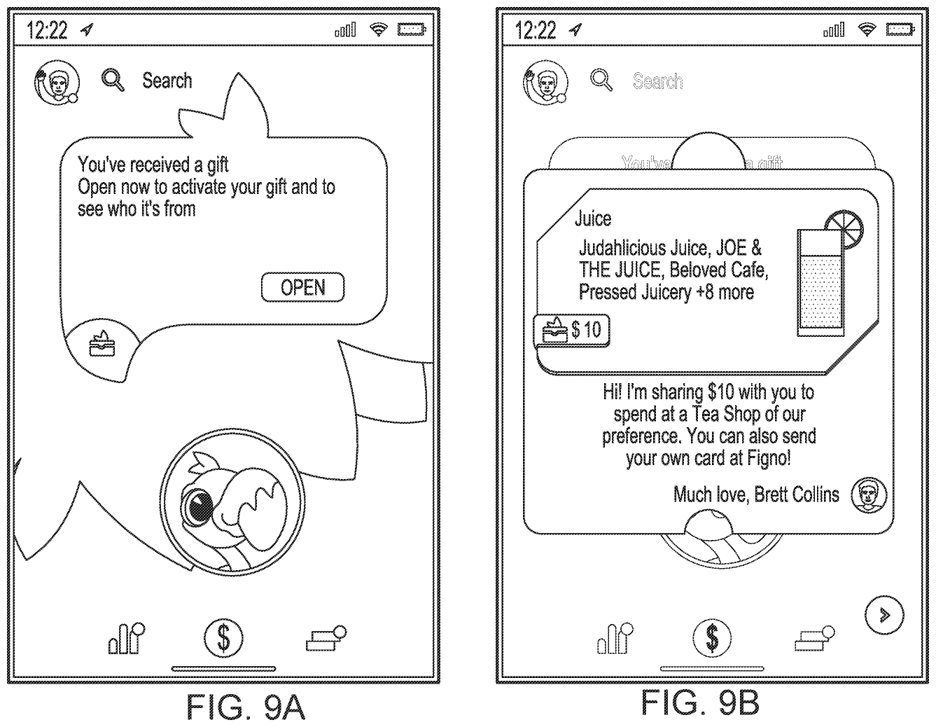

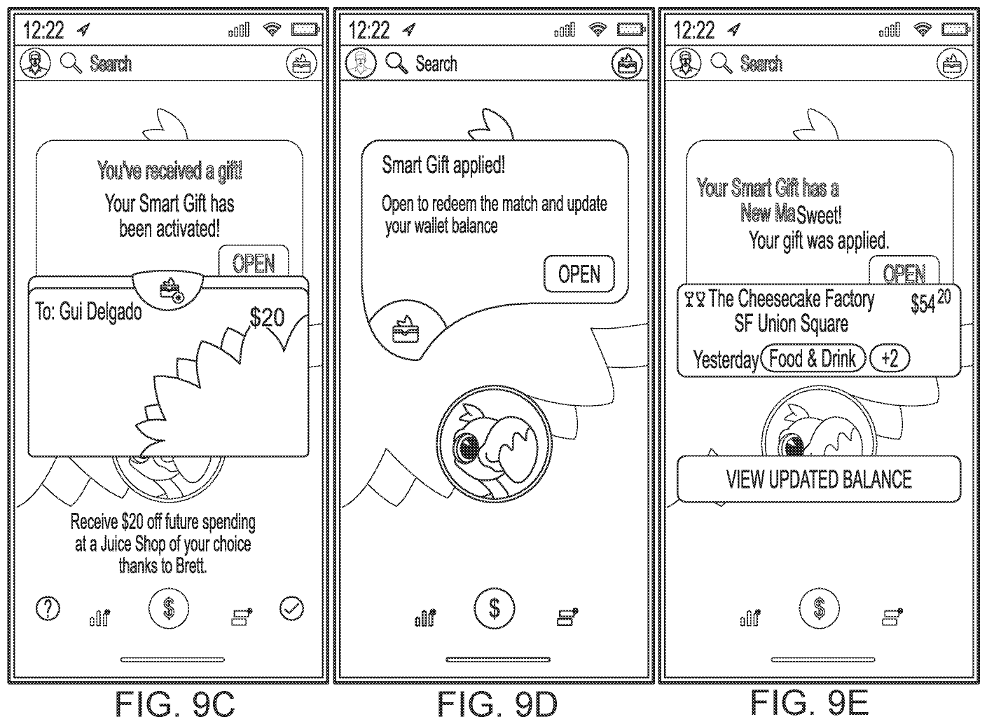

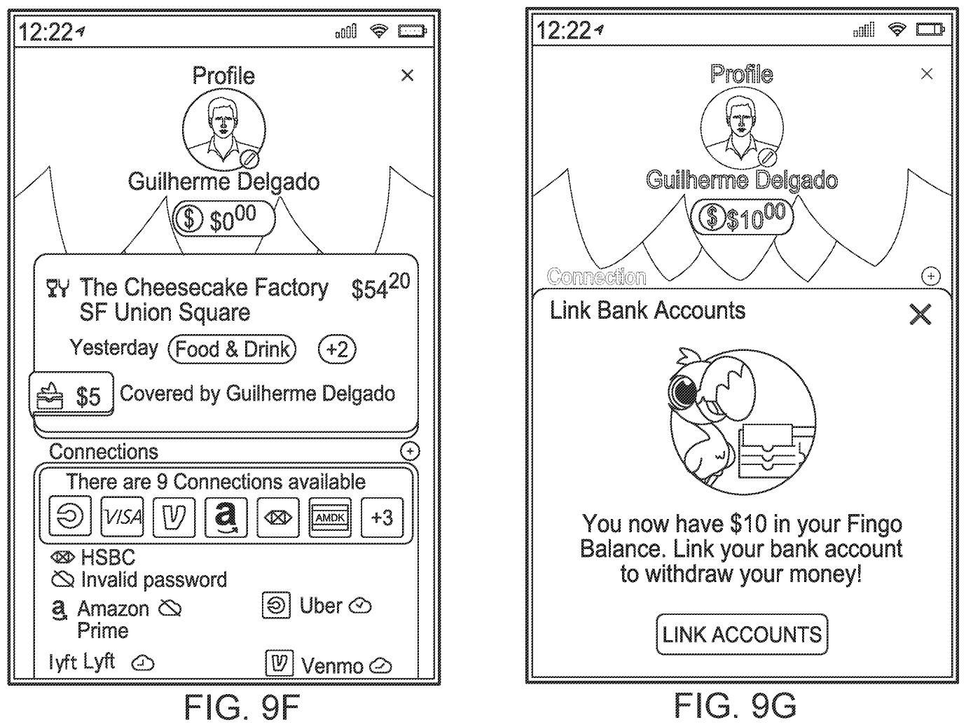

FIGS. 9A to 9G show an example of a gift receiving process. FIG. 9A is a user interface notifying a receiver that they have received a smart gift. FIG. 9B shows information associated with the smart gift including value and information about constraints associated with the smart gift. FIG. 9C shows a user interface indicating that the smart gift has been activated. FIG. 9D shows a user interface indicating that the smart gift system has applied the smart gift and indicating the recipient can click an “open” button to receive further details. FIG. 9E shows further details on how the smart gift system applied a particular smart gift. FIG. 9F shows a display that allows a recipient to select to which account the applied funds can be credited. FIG. 9G shows a user interface that allows a recipient to link a bank account, e.g., so that the user can withdraw funds from the user's smart gift system wallet/account.

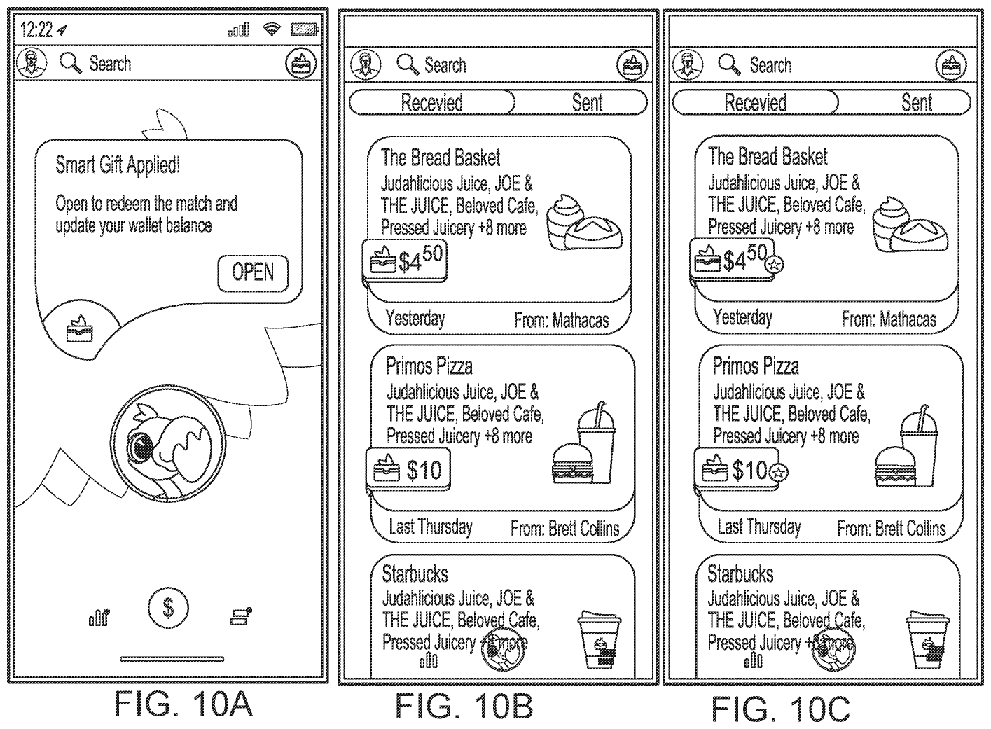

FIGS. 10A to 10C show an example of applying a gift to detected transactions. FIG. 10A shows a user interface indicating that the smart gift system has applied the smart gift and indicating the recipient can click an “open” button to receive further details. FIG. 10B shows a set of received smart gifts along with information about those smart gifts such as value and some constraint information. FIG. 10C shows the same set of received smart gifts but now some of the smart gifts have stars next to the value indicators indicating that the receiver still has money left to redeem on the card. If there are no stars next to the card as in FIG. 10B it indicates that there is no money left on the card.

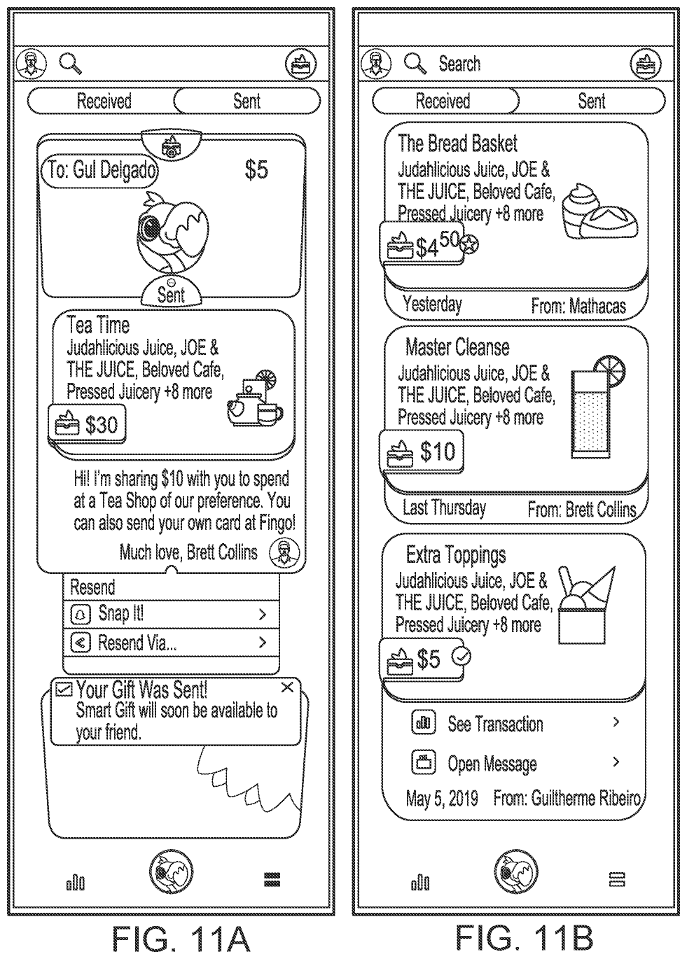

FIGS. 11A and 11B show an example of sent and received smart gifts. FIG. 11A shows a set of sent smart gifts and FIG. 11B shows a set of received smart gifts.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In this specification, the term “database” will be used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for delivering and distributing digital, and programmable gifts comprising:
receiving, at a smart gift system, a request from a gift sender for a smart gift, the request including at least one user customizable constraint and a specified value;
creating, at the smart gift system, the smart gift having the at least one user customizable constraint and a specified value;
receiving, at the smart gift system, a claim to the smart gift from a potential gift recipient;
receiving, at the smart gift system, authorization for access to at least one account of the potential gift recipient;
matching, at a constraint matching engine, a transaction reflected in the at least one account of the potential gift recipient to the at least one customizable and programmable constraint; and
transferring automatically, using a payment processor, at least a portion of the specified value to an account of the potential gift recipient in response to the matching.

2. The method of claim 1, wherein the method further comprises providing a smart gift shareable link to the gift sender, the smart gift shareable link configured to be forwarded by the gift sender to the potential gift recipient.

3. The method of claim 1, wherein the method further comprises receiving from the gift sender an indication of a recipient and forwarding the recipient a notification of the smart gift.

4. The method of claim 1, wherein the request further includes a personal text message and artwork from the gift sender.

5. The method of claim 1, wherein receiving authorization for access to at least one account of the potential gift recipient comprises receiving authorization to match a received smart gift to an activity at the at least one account.

6. The method of claim 1, wherein the method further comprises segregating the specified value into a holding account.

7. The method of claim 1, wherein the customizable and programmable constraint is provided by the user.

8. The method of claim 1, wherein the customizable and programmable constraint is an option the gift sender selects from a set of options presented to the gift sender.

9. The method of claim 1, wherein the matching comprises receiving transaction data from the at least one online account.

10. The method of claim 1, wherein the at least one customizable constraint comprises at least one geolocation constraint, at least one time constraint, or a combination of the at least one geolocation constraint and the at least one time constraint.

11. The method of claim 10, wherein the at least one customizable constraint is specified by the sender.

12. The method of claim 10, wherein the at least one customizable constraint does not specify a value of the smart gift, a recipient of the smart gift, or a sole merchant at which the smart gift can be redeemed.

13. The method of claim 1, wherein receiving a request from a gift sender for a smart gift comprises a specified value for the smart gift and an account from which the gift sender wants to withdraw the specified value to fund the smart gift.

14. The method of claim 1, wherein creating the smart gift comprises creating a shareable link that can access smart gift functionality and enticing sharing of the smart gift using the shareable link.

15. A method for delivering and distributing digital, and programmable comprising:
receiving, at a smart reward system, a request from a reward sender for a smart reward, the request including at least one customizable constraint and a specified value parameter;
segregating, at the smart reward system, the specified value into a holding account;
creating, at the smart reward system, the smart reward having the at least one user customizable constraint and a specified value;
receiving, at the smart reward system, a claim to the smart reward from a potential reward recipient;
receiving, at the smart reward system, authorization for access to at least one online account of the potential reward recipient;
matching, at a constraint matching engine, a transaction in the at least one online account of the potential reward recipient to the at least one customizable constraint; and
transferring, using a payment processor, at least a portion of the specified value to an account of the potential reward recipient in response to the matching.

16. The method of claim 15, wherein the reward sender is a merchant and specified value is a discount at the merchant.

17. A system comprising:
one or more computers and one or more storage devices on which are stored instructions that are operable, when executed by the one or more computers, to cause the one or more computers to perform operations comprising:
receiving, at a smart gift system, a request from a gift sender for a smart gift, the smart gift including at least one user customizable constraint and a specified value;
creating, at the smart gift system, the smart gift having the at least one user customizable constraint and the specified value;
receiving, at the smart gift system, a claim to the smart gift from a potential gift recipient;
receiving, at the smart gift system, authorization for access to at least one account of the potential gift recipient;
matching, at a constraint matching engine, a transaction reflected in the at least one account of the potential gift recipient to the at least one customizable and programmable constraint; and
transferring, using a payment processor, at least a portion of the specified value to an account of the potential gift recipient in response to the matching.

18. The system of claim 17, wherein the at least one customizable constraint comprises at least one geolocation constraint, at least one time constraint, or a combination of the at least one geolocation constraint and the at least one time constraint.

19. The system of claim 18, wherein the at least one customizable constraint is specified by the sender.

20. The system of claim 18, wherein the at least one customizable constraint does not specify a value of the smart gift, a recipient of the smart gift, or a sole merchant at which the smart gift can be redeemed.

21. The system of claim 17, wherein the operations further comprise providing a smart gift shareable link to the gift sender, the smart gift shareable link configured to be forwarded by the gift sender to the potential gift recipient.
